(19) United States
(12) Patent Application Publication
(10) Pub. No.: US 2025/0222889 A1
(43) Pub. Date: Jul. 10, 2025

(54) VEHICLE INTERIOR SYSTEM, METHOD FOR ADJUSTING INTERIOR COMPONENT, DEVICE AND MEDIUM

(71) Applicant: ZF ASIA PACIFIC AUTOMOTIVE SAFETY SYSTEMS (SHANGHAI) CO., LTD., Shanghai (CN)

(72) Inventors: Zhi ZHU, Shanghai (CN); Zhenfei WANG, Shanghai (CN); Zhiwei HUANG, Shanghai (CN); Tao LIU, Shanghai (CN); Yuanyi CHENG, Shanghai (CN)

(21) Appl. No.: 18/846,693

(22) PCT Filed: Mar. 14, 2023
(86) PCT No.: PCT/CN2023/081338

§ 371 Date: Sep. 13, 2024

(30) Foreign Application Priority Data
Mar. 15, 2022 (CN) 202210254109.2

(51) Int. Cl. B60R 16/037; B60N 2/02; B62D 1/181; G06T 7/246; G06T 7/73

(52) U.S. Cl. CPC B60R 16/037; G06T 7/246; G06T 7/73; B60N 2/0244; B62D 1/181; G06T 2207/30196; G06T 2207/30241; G06T 2207/30268

(57) ABSTRACT

The present disclosure provides a vehicle interior system, a method for adjusting an interior component, a device, and a medium. The vehicle interior system includes: an interior component including an infrared reflective material; a TOF camera provided in a cockpit of a vehicle; and an adjustment controller, including: a data acquisition module configured to acquire detection data from the TOF camera; a pose determination module configured to determine a pose of at least one occupant based on the detection data from the TOF camera; and an interior adjustment module configured to determine an adjustment strategy for the interior component based on a pose of at least one interior component and the pose of the occupant, to provide a best match between the pose of the interior component and the pose of the at least one occupant. In the present disclosure, the interior component is provided with the infrared reflective material, and the TOF camera is used to acquire the data to enable accurate determination of the pose of the occupant and the pose of the interior component, such that the adjustment strategy for the interior component can be accurately calculated, to avoid accidental interference between the interior component and the occupant during adjustment of the interior component.

### TECHNICAL FIELD

The present disclosure relates to the field of vehicle control technologies, and in particular, to a vehicle interior system, a method for adjusting an interior component, a device, and a medium.

### BACKGROUND OF THE INVENTION

With the continuous development of intelligence technologies, current automobiles are often equipped with intelligent cockpits to improve driver and passenger experience. In an intelligent cockpit of an automobile, relevant interior components can be adjusted as needed. For example, a steering wheel of the automobile can be retracted into a center console to increase the space of the cockpit, a seat of the automobile can be adjusted according to the body type and sitting posture of different passengers, etc.

However, the current control logic for the relevant interior components is not yet perfect, and cannot implement real-time monitoring and adjustment, failing to prevent damage to parts or injury to occupants in a timely manner in the case of interference between an interior component and a foreign object occurring in the course of motion, for example, in the case of blocking of an adjustment path for the interior component by the body of an occupant. To implement the real-time monitoring and adjustment, additional sensors will usually be considered to acquire motion data of the relevant interior components, which is not conducive to the integrated design of the intelligent cockpit.

### SUMMARY OF THE INVENTION

In view of the problem in the prior art, an objective of the present disclosure is to provide a vehicle interior system, a method for adjusting an interior component, a device, and a medium, in which an interior component is provided with an infrared reflective material, and a TOF camera is used to acquire data to enable accurate determination of the pose of an occupant and the pose of the interior component, such that a relative position of the occupant and the interior component can be accurately determined, to avoid accidental interference between the interior component and the occupant during adjustment of the interior component.

An embodiment of the present disclosure provides a vehicle interior system. The vehicle interior system includes:
an interior component provided in a cockpit of a vehicle, the interior component including an infrared reflective material;
a TOF camera provided in the cockpit of the vehicle; and
an adjustment controller, including:
a data acquisition module configured to acquire detection data from the TOF camera;
a pose determination module configured to determine a pose of at least one occupant based on the detection data from the TOF camera; and
an interior adjustment module configured to determine an adjustment strategy for the interior component based on a pose of at least one interior component and the pose of the occupant, to provide a best match between the pose of the interior component and the pose of the at least one occupant.

In some embodiments, the data acquisition module is configured to acquire the detection data from the TOF camera upon acquisition of a start signal of the TOF camera.

In some embodiments, the pose includes position information and posture information, where the pose information of the interior component and the pose information of the occupant are both determined based on the same reference coordinate system.

In some embodiments, the interior adjustment module includes:
a target acquisition module configured to acquire a target pose of each of one or more interior components corresponding to the at least one occupant;
a path planning module configured to determine an adjustment path for the interior component based on a current pose of the at least one interior component, the target pose thereof, and the pose of the at least one occupant, such that the adjustment path does not interfere with the pose of the occupant; and
an instruction sending module configured to generate an adjustment instruction based on the adjustment path, and send the adjustment instruction to the interior component.

In some embodiments, the path planning module is configured to determine the adjustment path for the interior component based on the pose of the at least one interior component and poses of a plurality of occupants, such that the adjustment path does not interfere with the plurality of occupants.

In some embodiments, the pose determination module is further configured to query a pre-stored current pose of the at least one interior component, or to determine the current pose of the at least one interior component based on the detection data from the TOF camera.

In some embodiments, the target acquisition module is configured to acquire a body parameter of the occupant, and determine the target pose based on the body parameter of the occupant by using a preset target pose calculation algorithm.

In some embodiments, the determining, by the target acquisition module, the target pose based on the body parameter of the occupant by using a preset target pose calculation algorithm includes: querying a mapping table between preset target poses and body parameters, to acquire the target pose corresponding to the body parameter of the occupant.

In some embodiments, the interior adjustment module further includes:
a motion simulation module configured to acquire poses of the occupant at different moments from the pose determination module, and predict a motion trajectory of the occupant based on the poses of the occupant at the different moments by using a preset motion trajectory prediction algorithm, to determine poses of the occupant at individual predetermined moments; and
an interference ascertainment module configured to ascertain whether the adjustment path planned by the path planning module may interfere with the motion trajectory of the occupant at the individual predetermined moments.

In some embodiments, the determining, by the pose determination module, the pose of each of the at least one occupant based on the detection data from the TOF camera includes:
determining a relative position of each of at least one feature point of the occupant and a reference point based on the detection data from the TOF camera; and
determining the pose of the at least one occupant based on the at least one feature point.

In some embodiments, the pose determination module is further configured to perform the following steps:
acquiring the detection data from the TOF camera;
determining a position of a fixed point in the vehicle based on the detection data; and
establishing an in-vehicle spatial coordinate system with the fixed point as the reference point.

In some embodiments, the system further includes:
a pose ascertainment module configured to ascertain whether a current pose of the interior component meets a preset condition for correct pose; and/or
a relative position ascertainment module configured to ascertain whether a relative position of the interior component and the occupant meets a preset condition for correct relative position.

In some embodiments, the interior component includes a vehicle seat assembly and/or a steering wheel assembly.

In some embodiments, the interior component further includes a seat belt assembly, where the seat belt assembly includes a fixed portion and a webbing portion, and pose information of the interior component includes at least position information of the webbing portion and a degree of twist of the webbing portion.

In some embodiments, the infrared reflective material is provided for the interior component in at least one of the following ways:
a surface of the interior component being coated with the infrared reflective material as a film;
a surface of the interior component being applied with the infrared reflective material as a coating; and
the infrared reflective material being mixed with a raw material of the interior component.

An embodiment of the present disclosure further provides a method for adjusting an interior component of a vehicle, where the interior component has a layer of infrared reflective material provided on a surface thereof, and the vehicle has at least one TOF camera provided therein.

The method includes the following steps:
acquiring detection data from the TOF camera;
determining a pose of each of at least one occupant based on the detection data from the TOF camera; and
determining an adjustment strategy for the interior component based on a pose of at least one interior component and the pose of the at least one occupant, to provide a best match between the pose of the interior component and the pose of the occupant.

In some embodiments, the determining an adjustment strategy for the interior component based on a pose of at least one interior component and the pose of the at least one occupant includes the following step:
acquiring a current pose of the at least one interior component;
acquiring a target pose of each of one or more interior components corresponding to the at least one occupant; and
determining an adjustment path for the interior component based on the current pose of the at least one interior component, the target pose thereof, and the pose of the at least one occupant, such that the adjustment path does not interfere with the pose of the occupant.

In some embodiments, the determining an adjustment strategy for the interior component based on a pose of at least one interior component and the pose of the at least one occupant includes the following step:
determining the adjustment strategy for the interior component based on the pose of the at least one interior component and poses of a plurality of occupants, such that the adjustment path for the interior component does not interfere with the plurality of occupants.

In some embodiments, the acquiring a current pose of the at least one interior component includes:
querying a pre-stored current pose of the at least one interior component, or determining the current pose of the at least one interior component based on the detection data from the TOF camera.

In some embodiments, the acquiring a target pose of each of one or more interior components corresponding to the at least one occupant includes the following steps: acquiring a body parameter of the occupant; and determining the target pose based on the body parameter of the occupant by using a preset target pose calculation algorithm.

In some embodiments, the determining the target pose based on the body parameter of the occupant by using a preset target pose calculation algorithm includes the following step:
querying a mapping table between preset target poses and body parameters, to determine the target pose corresponding to the body parameter of the occupant.

In some embodiments, after the determining an adjustment path for the interior component based on the current pose of the at least one interior component, the target pose thereof, and the pose of the at least one occupant, the method further includes the following steps:
predicting a motion trajectory of the occupant based on poses of the occupant at different moments by using a preset motion trajectory prediction algorithm, to determine poses of the occupant at individual predetermined moments;
ascertaining whether the adjustment path may interfere with the motion trajectory of the occupant at the individual predetermined moments; and
if yes, issuing an alarm notification; or
if no, generating an adjustment instruction based on the adjustment path, and sending the adjustment instruction to the interior component.

In some embodiments, the determining a pose of each of at least one occupant based on the detection data from the TOF camera includes the following steps:
determining a relative position of each of at least one feature point of the occupant and a reference point based on the detection data from the TOF camera; and
determining the pose of the occupant based on the at least one feature point.

In some embodiments, the method further includes the following steps:
acquiring the detection data from the TOF camera;
determining a position of a fixed point in the vehicle based on the detection data; and
establishing an in-vehicle spatial coordinate system with the fixed point as the reference point.

In some embodiments, after separately determining the current pose of the interior component and the pose of the occupant based on the detection data from the TOF camera, the method further includes the following steps:
ascertaining whether the current pose of the interior component meets a preset condition for correct pose, and/or ascertaining whether a relative position of the interior component and the occupant meets a preset condition for correct relative position; and
if the current pose of the interior component does not meet the preset condition for correct pose, and/or the relative position does not meet the preset condition for correct relative position, issuing an alarm notification.

In some embodiments, the interior component includes a vehicle seat assembly and/or a steering wheel assembly.

In some embodiments, the interior component further includes a seat belt assembly, where the seat belt assembly includes a fixed portion and a webbing portion, and pose information of the interior component includes at least position information of the webbing portion and a degree of twist of the webbing portion.

An embodiment of the present disclosure further provides a vehicle interior component adjustment device, including:
a processor; and
a memory storing instructions executable by the processor,
where the processor is configured to execute the steps of the described vehicle interior system by executing the executable instructions.

An embodiment of the present disclosure further provides a computer-readable storage medium for storing a program, where when the program is executed by a processor, the steps of the described vehicle interior system are implemented.

It should be understood that the above general description and the following detailed description are only exemplary and explanatory, and cannot limit the present disclosure.

The vehicle interior system, the method for adjusting an interior component, the device, and the medium according to the present disclosure have the beneficial effects as follows.

According to the present disclosure, the interior component is provided with the infrared reflective material, and the TOF camera is used to acquire the data to enable accurate determination of the pose of the interior component, and the TOF camera is also used to acquire the pose of the occupant to enable accurate determination of the relative position of the occupant and the interior component, such that the adjustment strategy for the interior component is accurately calculated, to avoid accidental interference between the interior component and the occupant during adjustment of the interior component, thereby preventing damage to the interior component or injury to the occupant due to the interference during the adjustment of the interior component.

### BRIEF DESCRIPTION OF DRAWINGS

Other features, objectives, and advantages of the present disclosure will become more apparent from reading the detailed description of non-limiting embodiments with reference to the following accompanying drawing.

FIG. 1 is a block diagram of a structure of a vehicle interior system according to a first embodiment of the present disclosure;

FIG. 2 is a schematic diagram of a structure of an interior adjustment module according to a first embodiment of the present disclosure;

FIG. 3 is a schematic diagram of a structure of an adjustment controller according to a second embodiment of the present disclosure;

FIG. 4 is a schematic diagram of a structure of an adjustment controller according to a third embodiment of the present disclosure;

FIG. 5 is a flowchart of a method for adjusting an interior component of a vehicle according to a first embodiment of the present disclosure;

FIG. 6 is a flowchart of determining an adjustment strategy in the method for adjusting an interior component of a vehicle according to the first embodiment of the present disclosure;

FIG. 7 and FIG. 8 are flowcharts in which the method for adjusting an interior component of a vehicle according to the first embodiment of the present disclosure is applied in a specific instance;

FIG. 9 is a flowchart of ascertaining whether a pose of an interior component is standardized in the method for adjusting an interior component of a vehicle, according to a second embodiment of the present disclosure;

FIG. 10 is a flowchart in which ascertaining whether a pose of an interior component is standardized according to the second embodiment of the present disclosure is applied in a specific instance;

FIG. 11 is a flowchart of ascertaining whether a relative position of an interior component and an occupant is standardized in the method for adjusting an interior component of a vehicle, according to a third embodiment of the present disclosure;

FIG. 12 is a flowchart in which ascertaining whether a relative position of an interior component and an occupant is standardized according to the third embodiment of the present disclosure is applied in a specific instance;

FIG. 13 is a schematic diagram of a structure of a vehicle interior component adjustment device according to an embodiment of the present disclosure; and

FIG. 14 is a schematic diagram of a structure of a computer-readable storage medium according to an embodiment of the present disclosure.

### DETAILED DESCRIPTION OF THE INVENTION

Now exemplary implementations will be described more fully with reference to the accompanying drawings. However, the exemplary implementations can be implemented in many forms and should not be construed as being limited to the examples set forth herein. On the contrary, these implementations are provided to make the present disclosure thorough and complete, and to fully convey the concept of the exemplary implementations to those skilled in the art. The described features, structures, or characteristics may be combined in one or more embodiments in any suitable manner.

In addition, the accompanying drawings are only schematic illustrations of the present disclosure, and are not necessarily drawn to scale. In the accompanying drawings, the same reference numerals denote the same or similar parts, and thus the repeated description thereof will be omitted. Some block diagrams shown in the accompanying drawings are functional entities, which do not necessarily correspond to physically or logically independent entities. These functional entities may be implemented in the form of software, in one or more hardware modules or integrated circuits, or in different networks and/or processor apparatuses and/or micro-controller apparatuses.

The flowcharts shown in the accompanying drawings are only exemplary illustrations, and do not necessarily include all steps. For example, some steps may be divided, and some steps may be combined or partially combined, and therefore an actual execution order thereof may change depending on an actual situation.

In order to solve the technical problem in the prior art, the present disclosure provides a vehicle interior system, in which a TOF camera is used to acquire pose data of an interior component and occupants. The interior component includes an infrared reflective material, at least one TOF camera is provided in a vehicle, and the interior component is then adjusted by an adjustment controller. In the present disclosure, the occupants are those who are seated inside the cockpit, including a driver and a passenger.

Various specific embodiments of the present disclosure are described in detail below in conjunction with the accompanying drawings. It will be appreciated that the specific embodiments are merely illustrative of the present disclosure, and are not to be construed as limiting the scope of protection of the present disclosure.

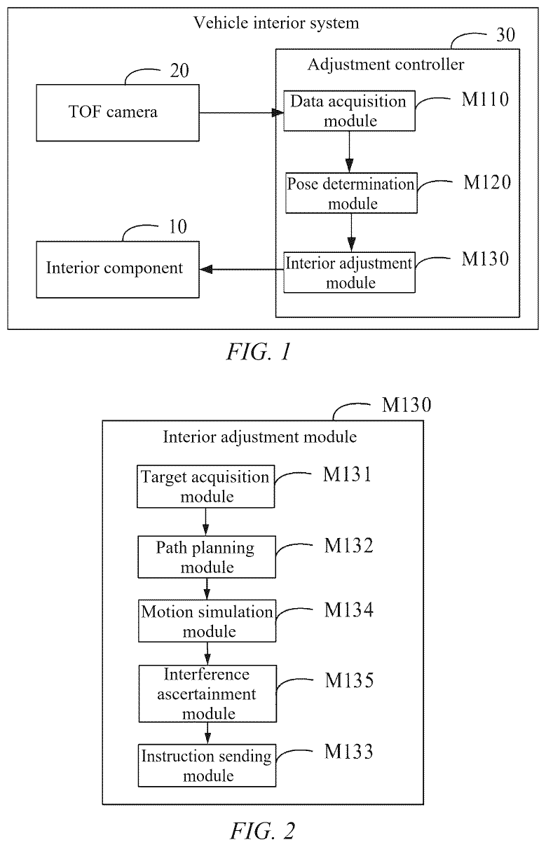

As shown in FIG. 1, in a first embodiment of the present disclosure, a vehicle interior system is provided. The vehicle interior system includes an interior component 10, a TOF camera 20, and an adjustment controller 30. The interior component is at least partially made of an infrared reflective material.

The interior component 10 includes one or more components located inside a cockpit of a vehicle, preferably including components, whose own pose can be adjusted, inside the cockpit of the vehicle. A pose of the interior component includes information of the position of the interior component body in a three-dimensional space, and/or an angle of rotation of part or all of the interior component relative to a rotation axis, etc.

For example, the interior component 10 may include at least one of the following: a) a vehicle seat assembly and a steering wheel assembly. The vehicle seat component specifically includes a seat body and a driving member (such as an electric motor) that drives the movement of the seat. The seat body is adjustable in pose under the drive of the driving member, where adjusting the pose of the vehicle seat includes, for example, moving the seat as a whole forward, rearward, left, right, up, and down inside the cockpit of the vehicle, for another example, adjusting an angle of inclination of a seat backrest about a pivot axis connecting the seat backrest and a seat cushion, for yet another example, adjusting an angle of inclination of the seat as a whole about a rotation axis, etc.

b) The steering wheel assembly specifically includes a steering wheel body and a driving member (such as an electric motor) that drives the movement of the steering wheel. Adjusting a pose of the steering wheel includes, for example, moving the steering wheel as a whole forward, rearward, left, right, up, and down inside the cockpit of the vehicle, and for another example, adjusting an angle of rotation of the steering wheel about a rotation axis, etc. Preferably, the steering wheel assembly also includes a foldable steering wheel, and the pose adjustment may also include driving folded and unfolded states of the steering wheel assembly, etc.

As a preferred solution, the interior component 10 may further include a seat belt assembly. The seat belt assembly includes a fixed portion and a webbing portion. Pose information of the interior component 10 includes at least position information of the webbing portion and a degree of twist of the webbing portion.

As an embodiment, depending on the position and configuration of the webbing portion of the seat belt, it may be determined whether the seat belt currently meets pose requirements during use. For example, depending on whether presence of the webbing of the seat belt assembly can be detected at a particular position (e.g., on feature points at the position of shoulder, chest, lumbar, etc.) on the body of the occupant, it is determined whether the seat belt assembly is currently in a normal position of use. For another example, based on information such as regarding whether the webbing is twisted or dangling, it is determined whether the current use of the seat belt assembly meets standard requirements.

The TOF camera 20 is provided inside the cockpit of the vehicle, and is used to photograph the cockpit of the vehicle to acquire detection data. TOF in the term “TOF camera” is an abbreviation for Time of Flight technology, the principle of which is as follows. The TOF camera emits outward a group of infrared or near infrared light, which is reflected after encountering an object. The TOF camera receives the reflected beam and calculates a time difference or a phase difference between the time at which the light is emitted and the time at which the light is received, to obtain depth information of a corresponding object. By collecting depth data in different directions and at different distances in a space, respective depth information of one or more objects in the space can be obtained. More preferably, the TOF camera may also establish a 3D model corresponding to a respective regional space based on the obtained depth information.

According to a preferred embodiment of the present solution, the system according to the present solution may include a plurality of TOF cameras. It will be appreciated by those skilled in the art that the way of obtaining depth data from a plurality of TOF cameras may be determined according to actual needs and circumstances. For example, the depth data from the plurality of TOF cameras may each be transmitted directly to the adjustment controller 30 and then integrated by the adjustment controller 30, or the depth data from the plurality of TOF cameras may be integrated and then transmitted to the adjustment controller 30, etc. This is not repeated.

According to a preferred embodiment of the present solution, since the interior component 10 is, partially or wholly, additionally made of an infrared reflective material with respect to other components inside the cockpit of the vehicle, the TOF camera can more effectively distinguish between the interior component according to the present solution and other components in the interior environment of the vehicle, thereby effectively detecting the position of the interior component 10. Thus, it is possible to avoid interference of other components with the pose detection of the interior component 10 according to the present solution, improving the accuracy of the pose detection of the interior component 10, and further facilitating an improvement in the accuracy of subsequent calculation of an adjustment strategy for the interior component 10.

The adjustment controller 30 is configured to determine the adjustment strategy for the interior component 10 based on the detection data from the TOF camera 20. Specifically, as shown in FIG. 1, in the first embodiment, the adjustment controller 30 includes:
a data acquisition module M110 configured to communicate with the TOF camera 20 and acquire the detection data from the TOF camera 20, where the data acquisition module M110 may be in wireless or wired communication with the TOF camera 20; a pose determination module M120 configured to determine a pose of at least one occupant based on the detection data from the TOF camera 20, where the pose of the occupant is position information and posture information of the occupant, and specifically, the pose of the occupant includes information about the position of the occupant in a three-dimensional space, and/or an angle of rotation of part or all of the body of the occupant relative to a rotation axis, etc.; and
an interior adjustment module M130 configured to determine the adjustment strategy for the interior component 10 based on a pose of at least one interior component 10 and the pose of the occupant, to provide a best match between the pose of the interior component 10 and the pose of the at least one occupant. Thus, the adjustment controller 30 can obtain the pose of the interior component 10 and the pose of the occupant based on the detection data from the TOF camera 20, and can thus accurately calculate the adjustment strategy for adjustment of the interior component 10. Here, the adjustment of the interior component 10 may include, for example, forward and rearward movement of the seat, a change in an angle of inclination of the seat back, unfolding and folding of the foldable steering wheel, etc.

In this embodiment, the adjustment strategy for the interior component 10 specifically includes whether the pose of the interior component 10 needs to be adjusted and if so, whether an adjustment path without interference can be planned. Here, the adjustment path without interference refers to the case where the interior component 10 does not spatially overlap the occupant during the adjustment of the interior component from the current pose along its adjustment path to the target pose, that is, there is no collision or cut between the interior component 10 and the occupant, etc. In determining the adjustment strategy for the interior component 10, the pose of only one occupant may be considered, or the poses of a plurality of occupants may be considered, such that the interior component 10 may achieve a best match with all the poses of the plurality of occupants.

According to the vehicle interior system of the present disclosure, the interior component 10 is provided with the infrared reflective material, and the TOF camera 20 is used to acquire the data to enable accurate determination of the pose of the interior component 10, and the TOF camera 20 is also used to acquire the pose of the occupant to enable accurate determination of the relative position of the occupant and the interior component 10, such that the adjustment strategy for the interior component 10 is accurately calculated, to avoid accidental interference between the interior component 10 and the occupant during adjustment of the interior component, thereby preventing damage to the interior component 10 or injury to the occupant due to the interference during the adjustment of the interior component 10.

The infrared reflective material is used to increase the reflectivity of a target object for infrared (MIR) or near infrared (NIR) beams. It can be applied as a coating to the surface of fabrics or leather, PU and other materials, or mixed in the fabrics as part of woven fibers, to improve the reflectivity of the surface of the fabrics, leather, PU, etc. for the infrared and/or near-infrared beams.

The infrared reflective material that may be used in the present disclosure includes, but is not limited to, Ti-series metal inorganics, Mg-series metal inorganics, Al-series metal inorganics, a mixed material of Ti-series metal inorganics and Al-series metal inorganics, a mixed material of Ti-series metal inorganics and Mg-series metal inorganics, a composite material of Ti/Mg/Al-series metal inorganics and a carbon material.

In this embodiment, the surface of the interior component 10 is coated with the infrared reflective material as a film. For example, in an implementation, the infrared reflective material may be applied directly to an outer surface of the interior component 10 in the form of a coating. In another alternative implementation, the infrared reflective material may also be mixed directly with the raw material of the interior component 10, that is, at the time of producing the interior component 10, a component having the infrared reflective material is produced. In still another alternative implementation, the infrared reflective material may be applied to the film first, and the film may then be coated on the surface of the interior component 10.

In this embodiment, the data acquisition module M110 is configured to acquire the detection data from the TOF camera 20 upon acquisition of a start signal of the TOF camera 20. In practical application, when a driver enters the interior of a vehicle and then starts the vehicle, the TOF camera 20 can be set to start immediately after the vehicle is ignited, either starting after the vehicle begins to run, or starting after the vehicle is ignited and a seat belt is worn by the driver/passenger. After the TOF camera 20 is started, the data acquisition module M110 and the TOF camera 20 are started to acquire the detection data from TOF camera 20. Further, after initial acquisition of the detection data from the TOF camera 20, the detection data from the TOF camera 20 may be acquired at preset intervals, or the detection data from the TOF camera 20 may be acquired upon receipt of a request for adjusting the interior component 10 from the occupant.

As a preferred embodiment of the present solution, the pose information of the interior component 10 and pose information of the occupant according to the present solution are both determined based on the same reference coordinate system. The reference coordinate system may be determined by the pose determination module M120. More preferably, the pose determination module M120 is further configured to determine an in-vehicle reference coordinate system before performing pose detection. Specifically, the pose determination module M120 determines the in-vehicle reference coordinate system through the following steps:
acquiring the detection data from the TOF camera 20;
determining a position of a fixed point in the vehicle based on the detection data; and
establishing an in-vehicle spatial coordinate system with the fixed point as a reference point.

The fixed point in the vehicle that serves as the reference point may be a preset point in the cockpit of the vehicle, or may be selected and set as needed. For example, the center of a center console of the vehicle is used as the reference point, or the center of a front seat is used as the reference point, etc. The direction of each coordinate axis of the in-vehicle spatial coordinate system may be determined based on other auxiliary points. For example, when the center of the center console of the vehicle is used as the reference point, a first auxiliary point on the left or right side of the center console is selected, and the direction of a line connecting the reference point and the first auxiliary point is used as the direction of a first coordinate axis; and a second auxiliary point directly behind or directly in front of the center console is selected, the direction of a line connecting the reference point and the second auxiliary point is used as the direction of a second coordinate axis. Once established, the in-vehicle spatial coordinate system can be used as a reference for the current pose detection of the interior component 10 and the occupant, or can be stored in a vehicle memory for future pose detection of the interior component 10 and the occupant.

In this embodiment, the determining, by the pose determination module M120, the pose of each of the at least one occupant based on the detection data from the TOF camera 20 includes:
determining a relative position of each of at least one feature point of the occupant and a reference point based on the detection data from the TOF camera 20, where the feature point here may be several key points of the occupant, e.g. key points, such as eyes, the nose, and the mouth, on the face of the occupant that may be used to determine a facial pose of the occupant, key points, such as elbows and knees, of the occupant that may be used to determine a limb pose of the occupant, etc., and the selection of the key point may be set and adjusted as needed; and
determining the pose of the at least one occupant based on the at least one feature point. In this embodiment, determining the pose of the occupant includes determining position information and posture information of the occupant. The position information of the occupant may be expressed in terms of a spatial coordinate range of the body of the occupant within the in-vehicle spatial coordinate system, and the posture information of the occupant may be expressed in terms of an angle of inclination of a particular part of the body of the occupant within the in-vehicle spatial coordinate system relative to a coordinate axis.

Preferably, according to the present solution, the position information includes, but is not limited to:
1) coordinate information; for example, three-dimensional coordinates of each point that are represented by (x, y, z) in the spatial coordinate system;
2) spatial volume; for example, a volumetric space of an object/a human body that is formed by being surrounded by a plurality of feature points and a fitted curve containing the feature points; and
3) classification information, for example, classifying a plurality of feature points, which are identified as being located on the same object (such as the interior component or the occupant) or on the same part of the same object, as feature points of the same category; and for another example, classifying a plurality of feature points, which are identified as being located on the head of the occupant, such as a nose feature point, a chin feature point, and an overhead feature point, as: feature points of the head. As a preferred embodiment, since the pose of the interior component 10 is relatively fixed, and generally does not change until it is adjusted, the frequency and time of pose detection of the interior component 10 may be different from the frequency and time of pose detection of the occupant. For example, the pose of the interior component 10 is detected less frequently, and thus the pose of the interior component 10 needs to be detected only once when the vehicle is started. After the interior component 10 has been adjusted according to the adjustment strategy, detection can be made once again to record the adjusted pose of the interior component 10. Subsequently, if the pose data of the interior component 10 needs to be used, the previously stored pose data can be queried, without the need to re-detect the pose of the interior component 10 each time the interior component is adjusted. On the contrary, the pose of the occupant may be set to be detected at preset intervals. In this embodiment, the pose determination module M120 is further configured to query a pre-stored current pose of the at least one interior component 10, or to determine the current pose of the at least one interior component 10 based on the detection data from the TOF camera 20. The pose of the interior component 10 includes position information and posture information.

In this embodiment, determining, by the pose determination module M120, the pose of the interior component 10 based on the detection data from the TOF camera 20 includes:
determining a relative position of each of at least one feature point of the interior component 10 and the reference point based on the detection data from the TOF camera 20, where the feature point here may be several key points of the interior component 10, for example, for the seat assembly, the pose of the seat body is detected based on key points preset on the armrest, backrest, and seat cushion of the seat body, and the selection of the key point may be set and adjusted as needed; and
determining the pose of the interior component 10 based on the at least one feature point. In this embodiment, determining the pose of the interior component 10 includes determining position information and posture information of the interior component 10. The position information of the interior component 10 may be expressed in terms of a spatial coordinate range of the body of the occupant within the in-vehicle spatial coordinate system, and the posture information of the interior component may be expressed in terms of an angle of inclination of a particular part of the interior component 10 within the in-vehicle spatial coordinate system relative to a coordinate axis.

As shown in FIG. 2, in the first embodiment, the interior adjustment module M130 includes:
a target acquisition module M131 configured to acquire a target pose of each of one or more interior components corresponding to the at least one occupant, where specifically, the target acquisition module M131 is configured to acquire a body size of the occupant, and calculate the target pose based on the body size of the occupant by using a preset target pose calculation algorithm;
a path planning module M132 configured to determine an adjustment path for the interior component based on a current pose of the at least one interior component, the target pose thereof, and the pose of the at least one occupant, such that the adjustment path does not interfere with the pose of the occupant, where the adjustment path planned here needs to meet two conditions: (1) a start point is the target pose of the interior component, and an end point is the target pose of the interior component; and (2) there is no interference between the adjustment path and the current pose of the occupant, i.e., it is ensured that the interior component does not spatially overlap the current pose of the occupant when the interior component moves along the adjustment path; and
an instruction sending module M133 configured to generate an adjustment instruction based on the adjustment path, and send the adjustment instruction to the interior component. Specifically, the instruction sending module M133 may send a signal including the adjustment instruction to the driving member (such as an electric motor or a hydraulic system) of the interior component, to control enabling and disabling of a driving function of the driving member (such as start-up and shutdown of the electric motor, and turning-on and turning-off of the hydraulic system), and to control the driving direction of the driving member (such as forward or reverse movement of the electric motor, and the driving direction of the hydraulic system), such that the interior component moves along the adjustment path to the target pose.

When there are a plurality of occupants in the vehicle, including, for example, a driver and one or more passengers, the path planning module M132 needs to take into account poses of the plurality of occupants when planning the adjustment path. For example, when adjusting the seat pose of the driver, it is necessary to consider not only whether the adjustment path for the seat of the driver interferes with the current pose of the driver, but also whether the adjustment path for the seat of the driver interferes with the pose of the occupant sitting behind the driver. If the seat of the driver is adjusted too far away from the center console, this will cause a great compression of space for the rear occupant, making it possible for the seat of the driver to collide with the rear occupant. Therefore, it is necessary to balance the situation of a plurality of occupants at the same time. Specifically, the path planning module M132 is configured to determine the adjustment path for the interior component based on the pose of the at least one interior component and poses of a plurality of occupants, such that the adjustment path does not interfere with the plurality of occupants.

In this embodiment, the target acquisition module M131 is configured to acquire a body parameter of the occupant, and determine the target pose based on the body parameter of the occupant by using the preset target pose calculation algorithm. Specifically, the target acquisition module M131 is configured to query a mapping table between preset target poses and body parameters, to obtain the target pose corresponding to the body parameter of the occupant. Here, the mapping table between target poses and body parameters can be obtained by establishing the mapping of different target poses to body parameters by pre-acquiring body parameters of many different users and their suitable target poses.

For example, for a seat assembly, when the seat body is farther away from the center console, the seat body needs to be adjusted forward for a relatively thin occupant. The seat body at the current pose is x1 meters away from the front panel, and x2 meters away from the front panel at the target pose, x1 meter being greater than x2 meter, that is, the path to move from the current position to the target position when the adjustment path is planned. When an angle a1 of inclination of the seat backrest at the current pose is large and the back of the occupant is not resting on the backrest, the angle of inclination of the seat backrest at the target pose is also set to a smaller value a2, that is, to rotate from the current angle a1 of inclination to the target angle a2 of rotation when the adjustment path is planned. Compared with the target pose, the current pose may also be subjected to both a change in position and a change in posture. The adjustment path is planned based on the target pose and the current pose, such that the target pose is obtained after adjustment from the current pose according to the adjustment path, and there is no interference with the pose of the occupant in the adjustment path.

In other alternative implementations, the target pose of the interior component may also be acquired in other manners. In an alternative implementation, the target pose of the interior component is determined depending on a start-up state of the vehicle. When the vehicle is started, the interior component needs to be adjusted to a first pose state, and the target pose then corresponds to the first pose state. When the vehicle is stopped, the interior component needs to be adjusted to a second pose state, and the target pose then corresponds to the second pose state. For example, when the vehicle is started, the seat backrest is adjusted to a posture with a smaller angle of inclination. When the vehicle is stopped, the seat backrest is adjusted to a posture with a larger angle of inclination, to facilitate the occupant to rest. The foldable steering wheel is automatically unfolded when the vehicle is started, and is automatically folded when the vehicle is stopped.

In another alternative implementation, the target pose of the interior component may also be acquired based on pre-set habits of the occupants. For example, an identity ID of each occupant and their corresponding target pose are pre-stored in a user database. After the occupant enters the vehicle, identification information of the occupant is acquired (e.g., by means of capture of Face ID by the TOF camera, fingerprint identification, facial image identification, password recognition, etc.), the identity ID of the occupant is determined, and then the pre-stored target pose corresponding to the identity ID of the occupant is acquired from the user database, such that the adjustment path is planned based on the target pose.

When the path planning module M132 plans the adjustment path, there may be a case where it is not possible to plan a path without interference, that is to say, it is not possible to obtain an adjustment path that simultaneously satisfies both of the conditions ((1) a start point is the target pose of the interior component, and an end point is the target pose of the interior component; and (2) there is no interference between the adjustment path and the current pose of the one or more occupants). In this case, the path planning module M132 may issue an alarm notification. The alarm notification may be issued by sound and/or light. For example, an alert tone is emitted to alert the occupant that there may be interference with the adjustment path and the adjustment cannot be performed. The occupant may then adjust their own pose, or adjust the target pose of the interior component.

Further, considering that the occupant may change the pose in the vehicle, a better adjustment strategy can be obtained if the pose of the occupant at each moment can be predicted in advance and whether the occupant will interfere with the interior component at each moment can be predicted. Thus, after the path planning module M132 has planned the adjustment path and before the instruction sending module M133 generates the adjustment instruction based on the adjustment path, the path planning module M132 also needs to predict whether the interior component will interfere with the moving occupant during the adjustment of the interior component based on the adjustment path.

In this embodiment, as shown in FIG. 2, the interior adjustment module M130 further includes:
a motion simulation module M134 configured to acquire poses of the occupant at different moments from the pose determination module, and predict a motion trajectory of the occupant based on the poses of the occupant at the different moments by using a preset motion trajectory prediction algorithm, to determine poses of the occupant at individual predetermined moments, where the poses of the occupant at different moments described herein are poses of the occupant at historical moments, the poses of the occupant at individual predetermined moments are poses of the occupant at individual predetermined moments over a period of time in the future, the time length of the period of time in the future here may be determined based on a scheduled completion time for the adjustment of the interior component, and the individual predetermined moments may be set as a plurality of points in time over a period of time in the future that have the same time intervals; and
an interference ascertainment module M135 configured to ascertain whether the adjustment path planned by the path planning module will interfere with the motion trajectory of the occupant at the individual predetermined moments. If no, it is determined that the adjustment path planned by the path planning module M132 is available, and the instruction sending module M133 may generate the adjustment instruction based on the adjustment path. If yes, an alarm notification is issued, that is, the occupant is informed that the occupant may interfere with the interior component during the adjustment process. The alarm notification may be issued by sound and/or light. After receiving the alarm notification, the occupant may need to adjust their own pose, or change their previously predetermined motion trend, or adjust the target pose of the interior component, to avoid interference with the adjustment path.

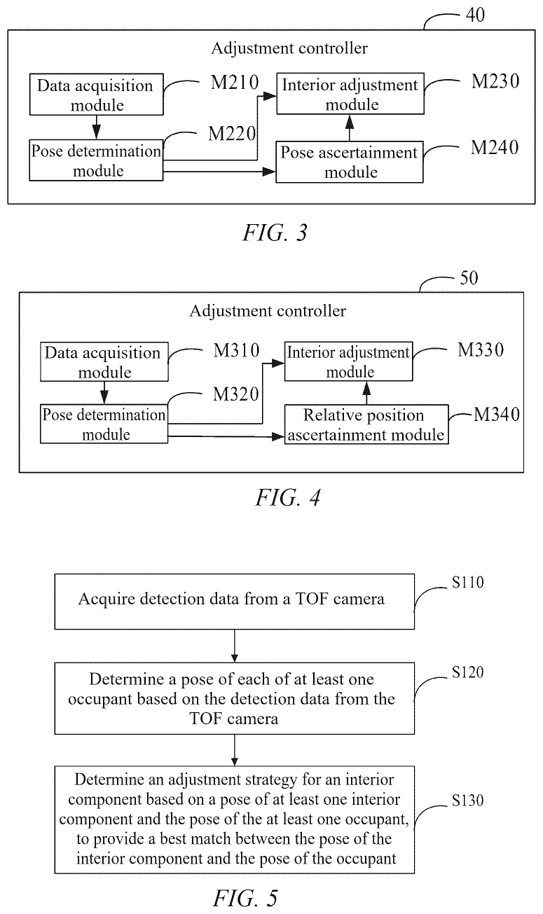

As shown in FIG. 3, it is a schematic diagram of a structure of an adjustment controller 40 in a vehicle interior system according to a second embodiment of the present disclosure. In this embodiment, the vehicle interior system also includes an interior component and a TOF camera. The structure and function of the interior component and the TOF camera may be the same as the structure and function of the interior component 10 and the TOF camera in the first embodiment, and will not be repeated here.

As shown in FIG. 3, in the second embodiment, the adjustment controller 40 includes:
a data acquisition module M210 configured to communicate with the TOF camera and acquire detection data from the TOF camera, where the data acquisition module M210 may be in wireless or wired communication with the TOF camera;
a pose determination module M220 configured to determine a pose of at least one occupant based on the detection data from the TOF camera, where the pose of the occupant is position information and posture information of the occupant, and the posture information of the occupant includes a body size and a body posture of the occupant; and
an interior adjustment module M230 configured to determine an adjustment strategy for the interior component based on a pose of at least one interior component and the pose of the occupant, to provide a best match between the pose of the interior component and the pose of the at least one occupant. Specifically, the interior adjustment module M230 may use the module composition of the interior adjustment module M130 as in the first embodiment described above and the functions of the individual modules shown in FIG. 2 to determine the adjustment strategy for the interior component so as to implement adjustment of the interior component, which will not be repeated herein.

The second embodiment differs from the first embodiment shown in FIG. 1 in that in the second embodiment, the adjustment controller 40 also includes further ascertaining whether the pose of the interior component is standardized. In this embodiment, specifically, as shown in FIG. 3, the adjustment controller 40 further includes:
a pose ascertainment module M240 configured to ascertain whether the current pose of the interior component meets a preset condition for correct pose. If no, an alarm notification is issued. The alarm notification may be issued by sound and/or light. After receiving the alarm notification, the occupant may adjust the pose of the interior component.

For example, when the interior component is the steering wheel assembly, the condition for correct pose is that the steering wheel is in the unfolded state after the vehicle is started. When the interior component is the seat assembly, the condition for correct pose is that the distance between the seat and a front panel is within a preset range of distances and the angle of inclination of the seat backrest is within a preset range of angles after the vehicle is started. When the interior component is the seat belt assembly, the condition for correct pose is that the seat belt has a flat surface and is not twisted. Further, when the pose ascertainment module M240 ascertains that the pose of the interior component does not meet the preset condition for correct pose, it is also possible to send the adjustment instruction to the interior adjustment module M330, such that the interior adjustment module M330 automatically corrects the pose of the interior component.

As shown in FIG. 4, it is a schematic diagram of a structure of an adjustment controller 50 in a vehicle interior system according to a third embodiment of the present disclosure. In this embodiment, the vehicle interior system also includes an interior component and a TOF camera. The structure and function of the interior component and the TOF camera may be the same as the structure and function of the interior component 10 and the TOF camera in the first embodiment, and will not be repeated here.

As shown in FIG. 4, in the third embodiment, the adjustment controller 50 includes:
a data acquisition module M310 configured to communicate with the TOF camera and acquire detection data from the TOF camera, where the data acquisition module M310 may be in wireless or wired communication with the TOF camera;
a pose determination module M320 configured to determine a pose of at least one occupant based on the detection data from the TOF camera, where the pose of the occupant is position information and posture information of the occupant; and
an interior adjustment module M330 configured to determine an adjustment strategy for the interior component based on a pose of at least one interior component and the pose of the occupant, to provide a best match between the pose of the interior component and the pose of the at least one occupant. Specifically, the interior adjustment module M330 may use the module composition of the interior adjustment module M130 as in the first embodiment described above and the functions of the individual modules shown in FIG. 2 to determine the adjustment strategy for the interior component so as to implement adjustment of the interior component, which will not be repeated herein.

The third embodiment differs from the first embodiment shown in FIG. 1 in that in the third embodiment, the adjustment controller 50 may further ascertain, based on the current pose of the interior component and the pose of the occupant, whether the relative position of the interior component and the occupant is standardized. Specifically, as shown in FIG. 4, the adjustment controller 50 further includes:
a relative position ascertainment module M340 configured to ascertain whether the relative position of the interior component and the occupant meets a preset condition for correct relative position. If yes, it is determined that the relative position is correct. If no, an alarm notification is issued.

For example, when the interior component is a seat belt, the condition for correct relative position is that the seat belt is correctly worn on the front side of the occupant. By ascertaining a relative position of the seat belt and the occupant, it is ascertained whether the seat belt has been correctly worn by the occupant. When the interior component is a seat, the condition for correct relative position is that the occupant is sitting upright in their seat. By ascertaining a relative position of the seat and the occupant, it is ascertained whether the occupant is sitting upright in their seat and whether the occupant has an undesirable sitting posture that may affect the driving safety. When the interior component is a steering wheel, the condition for correct relative position is that the distance between the steering wheel and the occupant such as a driver is within a preset allowable range. By ascertaining a relative position of the steering wheel and the driver, it is ascertained whether the steering wheel is too far from or too close to the driver. If the relative position between the interior component and the occupant does not meet the preset condition for correct relative position, an alarm notification is issued to alert the occupant to correct their own pose or the pose of the interior component. The occupant may correct the pose of the interior component by, for example, manually operating a seat adjustment button to adjust the pose of the seat or manually adjusting the wearing state of the seat belt, etc. Further, when the relative position ascertainment module M340 ascertains that the relative position does not meet the preset condition for correct relative position, it is also possible to send the adjustment instruction to the interior adjustment module M330, such that the interior adjustment module M330 automatically corrects the relative position.

In another optional embodiment, the second embodiment shown in FIG. 3 may also be combined with the third embodiment shown in FIG. 4. For example, the adjustment controller includes: the data acquisition module, the pose determination module, the pose ascertainment module, the relative position ascertainment module, and the interior adjustment module. The data acquisition module implements the function of the data acquisition module M210 or the data acquisition module M310, the pose ascertainment module implements the function of the pose determination module M220 or the pose determination module M320, and the interior adjustment module implements the function of the interior adjustment module M230 or the interior adjustment module M330. The pose determination module M220 inputs pose data into the pose ascertainment module or the relative position ascertainment module, the pose ascertainment module implements the function of the pose ascertainment module M240, and the relative position ascertainment module implements the function of the relative position ascertainment module M340.

The present disclosure further provides a method for adjusting an interior component of a vehicle. The interior component has a layer of infrared reflective material provided on a surface thereof, which is implemented in such a way that the surface of the interior component is coated with the infrared reflective material as a film, the surface of the interior component is applied with the infrared reflective material as a coating, or the infrared reflective material is mixed with a raw material of the interior component. The interior component may be a vehicle seat, a seat belt, or a foldable steering wheel, or may be other movable interior components. The vehicle has at least one TOF camera provided therein. The implementation process of the method for adjusting an interior component of a vehicle according to various embodiments of the present disclosure is described below in conjunction with the accompanying drawings.

As shown in FIG. 5, it is a flowchart of a method for adjusting an interior component of a vehicle according to the first embodiment of the present disclosure. The method may be implemented using the adjustment controller 30 in the vehicle interior system according to the first embodiment as shown in FIG. 1. Specifically, the method for adjusting an interior component of a vehicle includes the following steps.

S110: Acquire detection data from the TOF camera.

S120: Determine a pose of each of at least one occupant based on the detection data from the TOF camera, where the occupant may include a driver and a passenger.

S130: Determine an adjustment strategy for the interior component based on a pose of at least one interior component and the pose of the at least one occupant, to provide a best match between the pose of the interior component and the pose of the occupant.

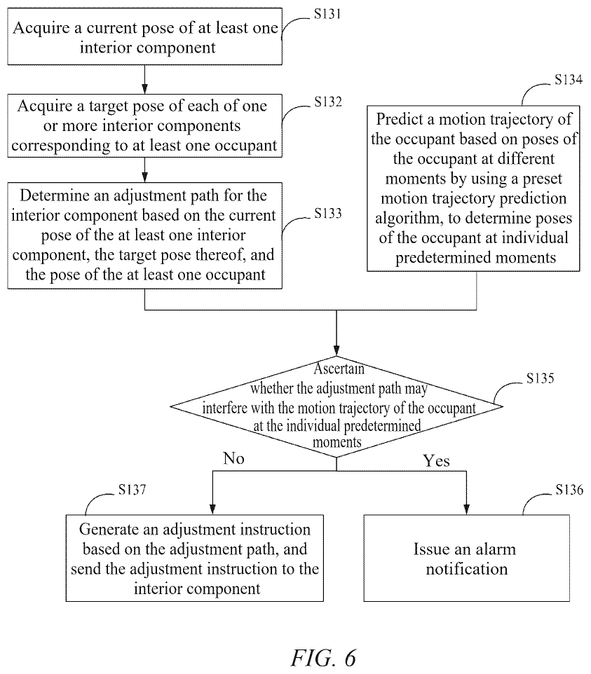

As shown in FIG. 6, in this embodiment, step S130 of determining an adjustment strategy for the interior component based on a pose of at least one interior component and the pose of the at least one occupant includes the following steps.

S131: Acquire a current pose of the at least one interior component. Specifically, the current pose of the at least one interior component may be determined based on the detection data from the TOF camera, or a pre-stored current pose of the at least one interior component may be queried, that is, the pose data previously stored after detection is directly queried without the need to re-detect the pose every time.

S132: Acquire a target pose of each of one or more interior components corresponding to the at least one occupant.

S133: Determine an adjustment path for the interior component based on the current pose of the at least one interior component, the target pose thereof, and the pose of the at least one occupant, such that the adjustment path does not interfere with the pose of the occupant. The adjustment path planned here needs to meet two conditions: (1) a start point is the target pose of the interior component, and an end point is the target pose of the interior component; and (2) there is no interference between the adjustment path and the current pose of the occupant, i.e., it is ensured that the interior component does not spatially overlap the current pose of the occupant when the interior component moves along the adjustment path, and there is no collision or cut between the interior component and the occupant when the interior component is adjusted.

When there are a plurality of occupants in the vehicle, including, for example, a driver and one or more passengers, poses of the plurality of occupants need to be taken into account when the adjustment path is planned. For example, when adjusting the seat pose of the driver, it is necessary to consider not only whether the adjustment path for the seat of the driver interferes with the current pose of the driver, but also whether the adjustment path for the seat of the driver interferes with the pose of the occupant sitting behind the driver. If the seat of the driver is adjusted too far away from the center console, this will cause a great compression of space for the rear occupant, making it possible for the seat of the driver to collide with the rear occupant. Therefore, it is necessary to balance the situation of a plurality of occupants at the same time. Specifically, in this embodiment, step S130 of determining an adjustment strategy for the interior component based on a pose of at least one interior component and the pose of the at least one occupant includes the following step:
determining the adjustment strategy for the interior component based on the pose of the at least one interior component and poses of a plurality of occupants, such that the adjustment path for the interior component does not interfere with the plurality of occupants.

In this embodiment, step S132 of acquiring a target pose of each of one or more interior components corresponding to the at least one occupant includes the following steps:
acquiring a body parameter of the occupant; and
determining the target pose based on the body parameter of the occupant by using a preset target pose calculation algorithm.

In an implementation, the determining the target pose based on the body parameter of the occupant by using a preset target pose calculation algorithm includes the following step:
querying a mapping table between preset target poses and body parameters, to determine the target pose corresponding to the body parameter of the occupant. Here, the mapping table between target poses and body parameters can be obtained by establishing the mapping of different target poses to body parameters by pre-acquiring body parameters of many different users and their suitable target poses.

For example, for a seat assembly, when the seat body is farther away from the center console, the seat body needs to be adjusted forward for a relatively thin occupant. The seat body at the current pose is x1 meters away from the front panel, and x2 meters away from the front panel at the target pose, x1 meter being greater than x2 meter, that is, the path to move from the current position to the target position when the adjustment path is planned. When an angle a1 of inclination of the seat backrest at the current pose is large and the back of the occupant is not resting on the backrest, the angle of inclination of the seat backrest at the target pose is also set to a smaller value a2, that is, to rotate from the current angle a1 of inclination to the target angle a2 of rotation when the adjustment path is planned. Compared with the target pose, the current pose may also be subjected to both a change in position and a change in posture. The adjustment path is planned based on the target pose and the current pose, such that the target pose is obtained after adjustment from the current pose according to the adjustment path, and there is no interference with the pose of the occupant in the adjustment path.

In other alternative implementations, the target pose of the interior component may also be acquired in other manners. In an alternative implementation, the target pose of the interior component is determined depending on a start-up state of the vehicle. When the vehicle is started, the interior component needs to be adjusted to a first pose state, and the target pose then corresponds to the first pose state. When the vehicle is stopped, the interior component needs to be adjusted to a second pose state, and the target pose then corresponds to the second pose state. For example, when the vehicle is started, the seat backrest is adjusted to a posture with a smaller angle of inclination. When the vehicle is stopped, the seat backrest is adjusted to a posture with a larger angle of inclination, to facilitate the occupant to rest. The foldable steering wheel is automatically unfolded when the vehicle is started, and is automatically folded when the vehicle is stopped.

As shown in FIG. 6, in this embodiment, after step S133 of determining an adjustment path for the interior component based on the current pose of the at least one interior component, the target pose thereof, and the pose of the at least one occupant, the method further includes the following steps.

S134: Predict a motion trajectory of the occupant based on poses of the occupant at different moments by using a preset motion trajectory prediction algorithm, to determine poses of the occupant at individual predetermined moments. The poses of the occupant at different moments described herein are poses of the occupant at historical moments, the poses of the occupant at individual predetermined moments are poses of the occupant at individual predetermined moments over a period of time in the future, the time length of the period of time in the future here may be determined based on a scheduled completion time for the adjustment of the interior component, and the individual predetermined moments may be set as a plurality of points in time over a period of time in the future that have the same time intervals.

S135: Ascertain whether the adjustment path may interfere with the motion trajectory of the occupant at the individual predetermined moments.

If yes, the process proceeds to S136: Issue an alarm notification, that is, informing the occupant that the occupant may interfere with the interior component during the adjustment process. The alarm notification may be issued by sound and/or light. After receiving the alarm notification, the occupant may need to adjust their own pose, or change their previously predetermined motion trend, or adjust the target pose of the interior component, to avoid interference with the adjustment path.

If no, the process proceeds to S137: Generate an adjustment instruction based on the adjustment path, and send the adjustment instruction to the interior component. For example, a signal including the adjustment instruction may be sent to the driving member (such as an electric motor or a hydraulic system) of the interior component, to control enabling and disabling of a driving function of the driving member (such as start-up and shutdown of the electric motor, and turning-on and turning-off of the hydraulic system), and to control the driving direction of the driving member (such as forward or reverse movement of the electric motor, and the driving direction of the hydraulic system), such that the interior component moves along the adjustment path to the target pose.

In this embodiment, step S120 of determining a pose of each of at least one occupant based on the detection data from the TOF camera includes the following steps: determining a relative position of each of at least one feature point of the occupant and a reference point based on the detection data from the TOF camera, where the feature point here may be several key points of the occupant, e.g. key points, such as eyes, the nose, and the mouth, on the face of the occupant that may be used to determine a facial pose of the occupant, key points, such as elbows and knees, of the occupant that may be used to determine a limb pose of the occupant, etc., and the selection of the key point may be set and adjusted as needed; and
determining the pose of the occupant based on the at least one feature point. In this embodiment, determining the pose of the occupant includes determining position information and posture information of the occupant. The position information of the occupant may be expressed in terms of a spatial coordinate range of the body of the occupant within the in-vehicle spatial coordinate system, and the posture information of the occupant may be expressed in terms of an angle of inclination of a particular part of the body of the occupant within the in-vehicle spatial coordinate system relative to a coordinate axis.

In this embodiment, the pose of the interior component and the pose of the occupant are based on the same in-vehicle spatial coordinate system. The method for adjusting an interior component of a vehicle further involves a step of pre-establishing the in-vehicle spatial coordinate system, which step specifically includes: acquiring detection data from the TOF camera;
determining a position of a fixed point in the vehicle based on the detection data; and
establishing the in-vehicle spatial coordinate system with the fixed point as the reference point.

The fixed point in the vehicle that serves as the reference point may be selected and set as needed. For example, the center of a center console of the vehicle is used as the reference point, or the center of a front seat is used as the reference point, etc. The direction of each coordinate axis of the in-vehicle spatial coordinate system may be determined based on other auxiliary points. For example, when the center of the center console of the vehicle is used as the reference point, a first auxiliary point on the left or right side of the center console is selected, and the direction of a line connecting the reference point and the first auxiliary point is used as the direction of a first coordinate axis; and a second auxiliary point directly behind or directly in front of the center console is selected, the direction of a line connecting the reference point and the second auxiliary point is used as the direction of a second coordinate axis. Once established, the in-vehicle spatial coordinate system can be used as a reference for current pose detection of the interior component and the occupant, or can be stored in a vehicle memory for future pose detection of the interior component and the occupant.

In this embodiment, determining the pose of the interior component based on the detection data from the TOF camera includes:
determining a relative position of each of at least one feature point of the interior component and the reference point based on the detection data from the TOF camera, where the feature point here may be several key points of the interior component, for example, for the seat assembly, the pose of the seat body is detected based on key points preset on the armrest, backrest, and seat cushion of the seat body, and the selection of the key point may be set and adjusted as needed; and
determining the pose of the interior component based on the at least one feature point. In this embodiment, determining the pose of the interior component includes determining position information and posture information of the interior component. The position information of the interior component may be expressed in terms of a spatial coordinate range of the body of the occupant within the in-vehicle spatial coordinate system, and the posture information of the interior component may be expressed in terms of an angle of inclination of a particular part of the interior component within the in-vehicle spatial coordinate system relative to a coordinate axis.

The pose of the interior component is relatively fixed, and generally does not change until it is adjusted. Therefore, the frequency and time of pose detection of the interior component may be different from the frequency and time of pose detection of the occupant. For example, the pose of the interior component is detected less frequently, and thus the pose of the interior component needs to be detected only once when the vehicle is started. After the interior component has been adjusted according to the adjustment strategy, detection can be made once again to record the adjusted pose of the interior component. Subsequently, if the pose data of the interior component needs to be used, the previously stored pose data can be queried, without the need to re-detect the pose of the interior component each time the interior component is adjusted. On the contrary, the pose of the occupant may be set to be detected at preset intervals.

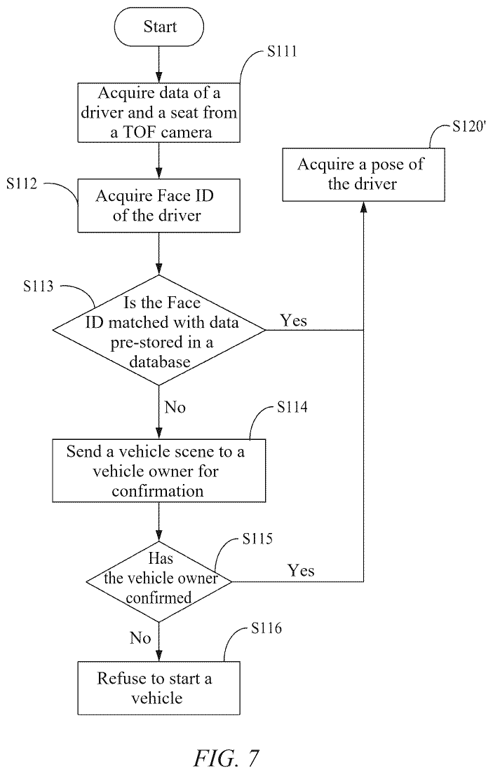

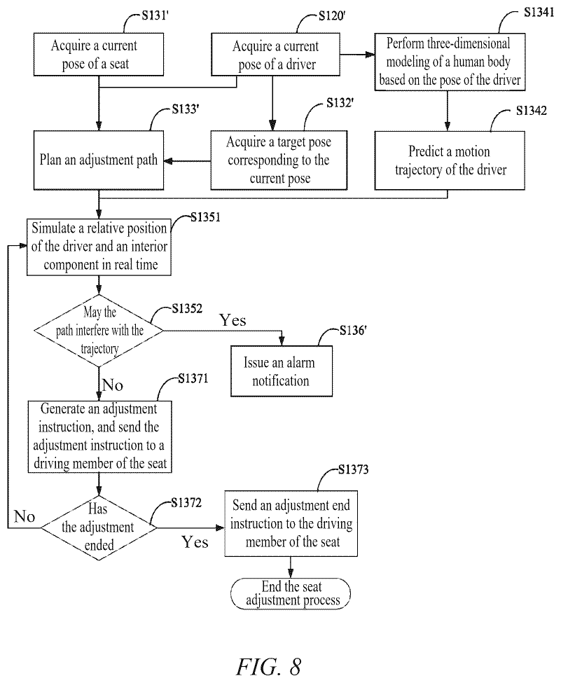

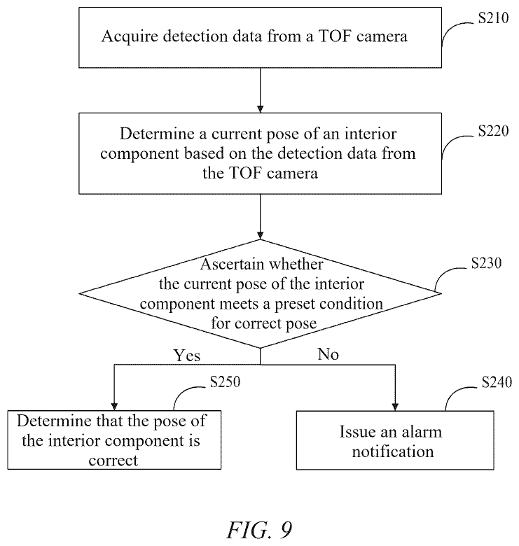

The process of adjusting the pose of the interior component in a specific instance is described in detail below in conjunction with FIG. 7 and FIG. 8. In FIG. 7 and FIG. 8, the occupant being a driver and the interior component being a seat is taken as an example for description. In other alternative implementations, the occupant is also not limited to the driver, but may also include a passenger on the passenger seat, a passenger on the back seat, etc. The interior component is also not limited to the seat, but may also be a seat belt, a steering wheel, etc. In order to clearly show the overall flow, FIG. 7 schematically shows a refined implementation of steps S110 and S120 of FIG. 5 in a specific instance. Specifically, steps S111 to S116 of FIG. 7 are refinements of step S110 of FIG. 5 in an instance, and step S120′ is specific application of step S120 of FIG. 5 in an instance. FIG. 8 mainly shows a refined implementation of steps S131 to S137 of FIG. 6 in a specific instance, and also shows step S120′ of FIG. 7 in order to maintain consistency with FIG. 7. Specifically, in FIG. 8, step S131′ is specific application of step S131 in a specific instance, step S132′ is specific application of step S132 of FIG. 6 in a specific instance, steps S1341 and S1342 are refinements of S134 of FIG. 6 in a specific instance, steps S1351 and S1352 are refinements of S135 of FIG. 6 in a specific instance, steps S1371 to S1373 are refinements of S137 of FIG. 6 in a specific instance, and S133′ and S136′ are specific application of S133 and S136 of FIG. 6.

As shown in FIG. 7, first, after the driver has bordered the vehicle, a TOF camera is used to observe the driver and the seat. Then, the following steps are performed.

S111: Acquire detection data of the driver and the seat that are observed by the TOF camera.

S112: Acquire a Face ID of the driver based on the detection data from the TOF camera.

S113: Ascertain whether the Face ID of the driver is matched with pre-stored Face ID data of a vehicle owner and other persons allowed to drive the vehicle in a database.

If successfully matched, the process proceeds to step S120′: Acquire a pose of the driver based on the detection data from the TOF camera.

If unsuccessfully matched, the process proceeds to step S114: Send a vehicle scene to the vehicle owner for confirmation (e.g., send a picture of the driver to the vehicle owner).

S115: Ascertain whether the vehicle owner has confirmed that the current driver can drive the vehicle.

If confirmed, the process proceeds to step S120′.

If not confirmed by the vehicle owner, the process proceeds to step S116: Refuse to start the vehicle.

As shown in FIG. 8, after step S120′ is performed, the following steps are also performed.

S131′: Acquire a current pose of the seat.

S132′: Acquire a target pose corresponding to the current pose.

S133′: Plan an adjustment path based on the current pose of the seat and the pose of the driver, such that the planned adjustment path starts with the target pose of the seat and ends with the target pose of the seat.

Steps S132′ and S132′ may be performed in parallel, or step S131′ may be performed first, followed by step S132′, or step S132′ may be performed first, followed by step S131′.

During planning, if an adjustment path that does not interfere with the current pose of the driver cannot be planned, an alarm notification is issued, that is, the driver is informed that the driver may interfere with the seat during the adjustment process. The alarm notification may be issued by sound and/or light. After receiving the alarm notification, the driver may need to adjust their own pose, or change their previously predetermined motion trend, or adjust the target pose of the seat, to avoid interference with the adjustment path.

Therefore, after step S120′ is performed, the following steps are also performed.

S1341: Perform three-dimensional modeling of a human body based on the pose of the driver.

S1342: Acquire poses of the driver at different moments, and predict a motion trajectory of the driver based on the poses of the driver at the different moments by using a preset motion trajectory prediction algorithm, the predicted motion trajectory of the driver including predicted poses of the driver at individual predetermined moments over a specific period of time in the future.

Steps S1341 and S1342 may be performed in parallel with steps S131′ to S133′, or steps S131′ to S133′ may be performed first, followed by steps S1341 and S1342, or steps S1341 and S1342 may be performed first, followed by step S131′ to S133′.

S1351: Simulate, in real time, a relative positional relationship between the driver and the seat at individual predetermined moments over a specific period of time in the future, based on the three-dimensional modeling of the human body, the motion trajectory of the driver, and the planned adjustment path.

S1352: Ascertain, based on the simulated relative positional relationship, whether the adjustment path may interfere with the motion trajectory of the driver.

If the adjustment path may interfere with the motion trajectory of the driver, the process proceeds to S136: Issue an alarm notification, that is, informing the driver that the driver may interfere with the seat during the adjustment process. The alarm notification may be issued by sound and/or light. After receiving the alarm notification, the driver may need to adjust their own pose, or change their previously predetermined motion trend, or adjust the target pose of the seat, to avoid interference with the adjustment path.

If the adjustment path may not interfere with the motion trajectory of the driver, the process proceeds to step S1371: Generate an adjustment instruction based on the adjustment path, and send the adjustment instruction to a driving member of the seat.

S1372: Ascertain whether the adjustment has ended.

If has ended, the process proceeds to S1373: Send an adjustment end instruction to the driving member of the seat, and then end the seat adjustment process.

If has not yet ended, the process returns to step S1351.

In this embodiment, during the adjustment of the interior component, a corresponding prompt signal may be issued in different states. For example, after the adjustment path is determined, if it is ascertained, through step S135 in FIG. 6, that there is no interference, indicating that the adjustment can proceed normally, a first prompt signal, such as a flashing green light, is issued. If it is ascertained, through step S135, that there may be interference, a second prompt signal, such as a flashing red light, is issued, to prompt that the occupant cannot proceed with the adjustment.

A second embodiment of the present disclosure further provides a method for adjusting an interior component of a vehicle. The method for adjusting an interior component of a vehicle in this embodiment may be implemented using the adjustment controller 40 as shown in FIG. 3. In this embodiment, the method for adjusting an interior component of a vehicle includes a step of planning an adjustment path and adjusting the interior component. The step may be implemented using steps S110 to S130 (including S131 to S137) as shown in FIG. 5 and FIG. 6, and will not be repeated herein.

In the second embodiment, the method for adjusting an interior component of a vehicle may further include a step of ascertaining whether the current pose of the interior component is standardized. The step is not sequential with the step of planning the adjustment path and adjusting the interior component, i.e., they can be performed at the same time, or separately at different times as needed.

As shown in FIG. 9, in the second embodiment, ascertaining whether the current pose of the interior component is standardized includes the following steps.

S210: Acquire detection data from the TOF camera.

S220: Separately determine the current pose of the interior component and a pose of an occupant based on the detection data from the TOF camera, where the occupant may include a driver and a passenger.

S230: Ascertain whether the current pose of the interior component meets a preset condition for correct pose.

If no, the process proceeds to step S240: Issue an alarm notification. The alarm notification may be issued by sound and/or light. After receiving the alarm notification, the occupant may adjust the pose of the interior component.

If yes, the process proceeds to step S250: Determine that the pose of the interior component is correct, and then end the interior component adjustment process.

For example, when the interior component is the steering wheel assembly, the condition for correct pose is that the steering wheel is in the unfolded state after the vehicle is started. When the interior component is the seat assembly, the condition for correct pose is that the distance between the seat and a front panel is within a preset range of distances and the angle of inclination of the seat backrest is within a preset range of angles after the vehicle is started. When the interior component is the seat belt assembly, the condition for correct pose is that the seat belt has a flat surface and is not twisted.

Both the step of ascertaining whether the current pose of the interior component is standardized (hereinafter referred to as step A) and the step of planning the adjustment path and adjusting the interior component (hereinafter referred to as step B) include a sub-step of acquiring the detection data from the TOF camera, and separately determining the current pose of the interior component and the pose of the occupant based on the detection data from the TOF camera (hereinafter referred to as sub-step C). In steps A and B, sub-step C may be performed only once, and both the obtained pose of the interior component and the obtained pose of the occupant may be used to plan the path and ascertain whether the pose of the interior component is standardized. Alternatively, sub-step C may be performed once in step A alone, and the pose of the interior component and the pose of the occupant are obtained and then used to ascertain whether the current pose of the interior component is correct, and then sub-step C may be performed once in step B alone, and the pose of the interior component and the pose of the occupant are obtained and used to plan the path and adjust the interior component. Alternatively, sub-step C may be performed once in step B alone, and the pose of the interior component and the pose of the occupant are obtained and used to plan the path and adjust the interior component, and then sub-step C may be performed once in step A alone, and the pose of the interior component and the pose of the occupant are obtained and then used to ascertain whether the current pose of the interior component is correct.

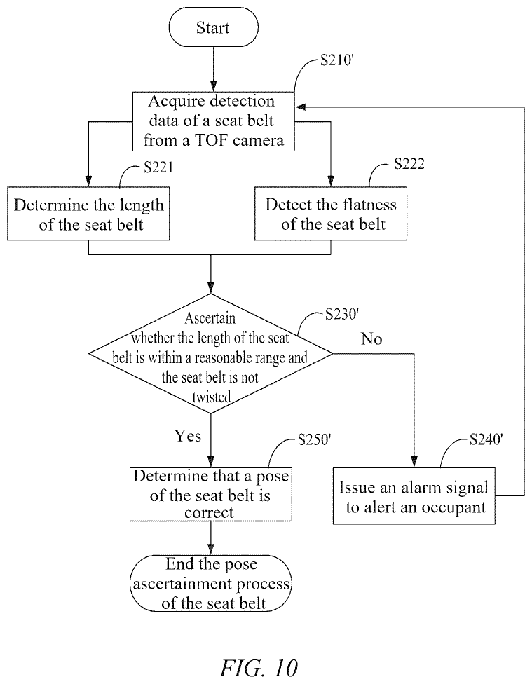

As shown in FIG. 10, it is a flowchart of pose ascertainment of a seat belt in a specific instance. In this embodiment, the steps in FIG. 9 are refined using an example where the interior component is the seat belt. Steps S221 and S222 of FIG. 10 are refinements of step S220 of FIG. 9 in a specific instance, and steps S210′, S230′, S240′, and S250′ of FIG. 10 are all specific application of steps S210, S230, S240, and S250 of FIG. 9 in a specific instance.

As shown in FIG. 10, after an occupant (a driver or a passenger) has boarded the vehicle, the TOF camera observes the occupant and the seat belt. Then, the following steps are performed.

S210′: Acquire detection data of the seat belt from the TOF camera.

S221: Determine the length of the seat belt based on the detection data of the seat belt.

S222: Determine the flatness of the seat belt based on the detection data of the seat belt.

S230′: Ascertain whether the length of the seat belt is within a reasonable range and the seat belt is not twisted.

If no, the process proceeds to S240′: Issue an alarm notification to alert the occupant that the seat belt is not correctly worn. After receiving the alarm notification, the occupant may adjust the seat belt.

If yes, the process proceeds to S250′: Ascertain that the pose of the seat belt is correct, and then end the current pose ascertainment process of the seat belt.

A third embodiment of the present disclosure further provides an interior component adjustment method. The interior component adjustment method according to this embodiment may be implemented using the adjustment controller 50 as shown in FIG. 4. In this embodiment, the interior component adjustment method includes a step of planning an adjustment path and adjusting an interior component. The step may be implemented using steps S110 to S130 (including S131 to S137) as shown in FIG. 5 and FIG. 6, and will not be repeated herein.

In the third embodiment, the interior component adjustment method may further include a step of ascertaining whether a relative position of the interior component and the occupant is standardized. The step is not sequential with the step of planning the adjustment path and adjusting the interior component, i.e., they can be performed at the same time, or separately at different times as needed.

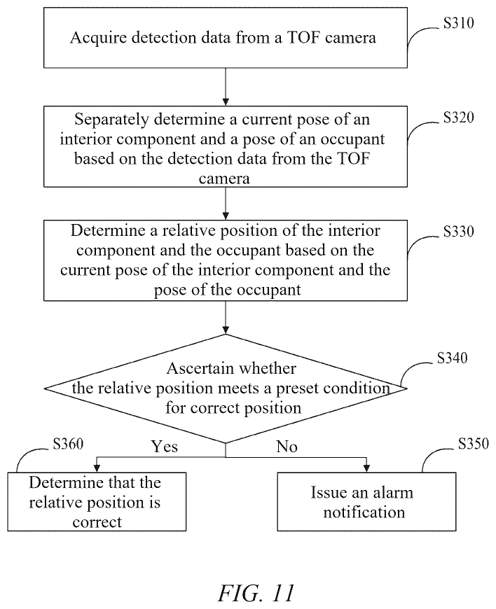

As shown in FIG. 11, in the third embodiment, the step of ascertaining whether a relative position of the interior component and the occupant is standardized specifically includes the following sub-steps.

S310: Acquire detection data from the TOF camera.

S320: Separately determine the current pose of the interior component and a pose of the occupant based on the detection data from the TOF camera, where the occupant may include a driver and a passenger.

S330: Determine the relative position of the interior component and the occupant based on the current pose of the interior component and the pose of the occupant.

S340: Ascertain whether the relative position meets a preset condition for correct relative position.

If no, the process proceeds to S350: Issue an alarm notification. The alarm notification may be issued by sound and/or light. After receiving the alarm notification, the occupant may adjust the position of the interior component, or adjust their own pose.

If yes, the process proceeds to S360: Determine that the relative position is correct, and then end the position ascertainment process of the seat belt.

For example, when the interior component is a seat belt assembly, the condition for correct relative position is that a seat belt is correctly worn on the front side of the occupant, the seat belt is approximately located at the center of the occupant, and the seat belt extends from one shoulder of the occupant to the waist. By ascertaining a relative position of the seat belt and the occupant, it is ascertained whether the seat belt has been correctly worn by the occupant. When the interior component is a seat assembly, the condition for correct relative position is that the occupant is sitting upright in their seat. By ascertaining a relative position of the seat and the occupant, it is ascertained whether the occupant is sitting upright in their seat and whether the occupant has an undesirable sitting posture that may affect the driving safety. When the interior component is a steering wheel assembly, the condition for correct position is that the distance between a steering wheel and the occupant such as a driver is within a preset allowable range. By ascertaining a relative position of the steering wheel and the driver, it is ascertained whether the steering wheel is too far from or too close to the driver. If the relative position between the interior component and the occupant does not meet the preset condition for correct position, an alarm notification is issued to alert the occupant to correct their own pose or the pose of the interior component.

Both the step of ascertaining whether the relative position of the interior component and the occupant is standardized (hereinafter referred to as step D) and the step of planning the adjustment path and adjusting the interior component (hereinafter referred to as step B) include a sub-step of acquiring the detection data from the TOF camera, and separately determining the current pose of the interior component and the pose of the occupant based on the detection data from the TOF camera (hereinafter referred to as sub-step C). In steps D and B, sub-step C may be performed only once, and both the obtained pose of the interior component and the obtained pose of the occupant may be used to plan the adjustment path and ascertain whether the relative position is standardized. Alternatively, sub-step C may be performed once in step D alone, and the pose of the interior component and the pose of the occupant are obtained and then used to ascertain whether the relative position is standardized, and then sub-step C may be performed once in step B alone, and the pose of the interior component and the pose of the occupant are obtained and then used to plan the path and adjust the interior component. Alternatively, sub-step C may be performed once in step B alone, and the pose of the interior component and the pose of the occupant are obtained and then used to plan the path and adjust the interior component, and then sub-step C may be performed once in step D alone, and the pose of the interior component and the pose of the occupant are obtained and then used to ascertain whether the relative position is standardized.

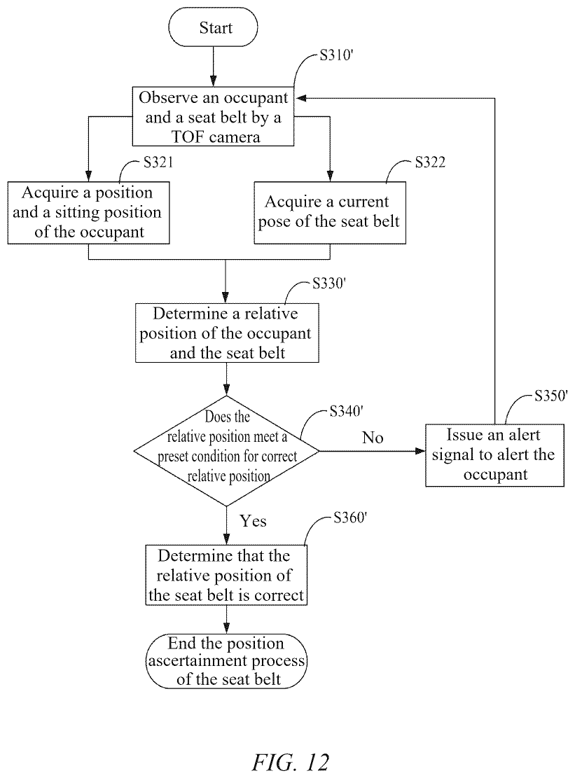

As shown in FIG. 12, it is a flowchart of ascertaining a relative position of a seat belt and an occupant in a specific instance. In this embodiment, the steps in FIG. 11 are refined using an example where the interior component is the seat belt. Steps S321 and S322 of FIG. 12 are refinements of step S320 of FIG. 11 in a specific instance, and steps S310′, S330′, S340′, S350′, and S360′ of FIG. 12 are all specific application of steps S310, S330, S340, S350, and S360 of FIG. 11 in a specific instance.

As shown in FIG. 12, after an occupant (a driver or a passenger) has boarded the vehicle, the TOF camera observes the occupant and the seat belt. Specifically, the following steps are performed.

S310′: Acquire detection data of the occupant and the seat belt that are observed by the TOF camera.

S321: Acquire a position and a sitting posture of the occupant based on the detection data from the TOF camera.

S322: Acquire a current pose of the seat belt based on the detection data from the TOF camera.

S330′: Determine the relative position of the occupant and the seat belt based on the position and sitting posture of the occupant, and the current pose of the seat belt.

S340′: Ascertain whether the relative position of the occupant and the seat belt meets a preset condition for correct relative position, for example, ascertain whether the seat belt extends from one shoulder of the occupant to the waist of the occupant and whether the seat belt is approximately located at the center of the occupant.

If no, the process proceeds to step S350′: Emit an alert signal to alert the occupant that the occupant may adjust the seat belt.

If yes, the process proceeds to step S360′: Determine that the relative position of the seat belt is correct, and then end the current position ascertainment process of the seat belt.

In a specific implementation, the interior component pose ascertainment shown in FIG. 9 may also be applied in combination with the relative position ascertainment of the interior component and the occupant shown in FIG. 11. For example, some particular functions are allowed to enable, only when it is ascertained, through the step in FIG. 9, that the interior component meets the preset condition for correct pose and it is ascertained, through the step in FIG. 11, that the relative position between the interior component and the occupant meets the condition for correct relative position. For example, the pose ascertainment for the seat belt in FIG. 10 is applied in combination with the relative position ascertainment for the seat belt and the occupant in FIG. 12. It is ascertained that the seat belt is correctly worn, only when it is ascertained, through the step in FIG. 10, that the pose of the seat belt is correct and it is ascertained, through the step in FIG. 12, that the relative position of the seat belt and the occupant is correct. After it is determined that the seat belt is correctly worn, an anti-collision protection strategy can be further developed for the occupant based on the body size of the occupant and the pose of the seat belt.

An embodiment of the present disclosure further provides a vehicle interior component adjustment device. The device includes: a processor; and a memory storing instructions executable by the processor, where the processor is configured to execute the steps of the described vehicle interior system by executing the executable instructions.

Those skilled in the art can understand that various aspects of the present disclosure can be implemented as a system, a vehicle interior component adjustment device, or a program product. Accordingly, each aspect of the present disclosure may be specifically implemented in the form of: an entirely hardware implementation, an entirely software implementation (including firmware, microcode, etc.), or an implementation combining hardware and software aspects, which may be collectively referred to herein as a “circuit”, “module”, or “platform”.

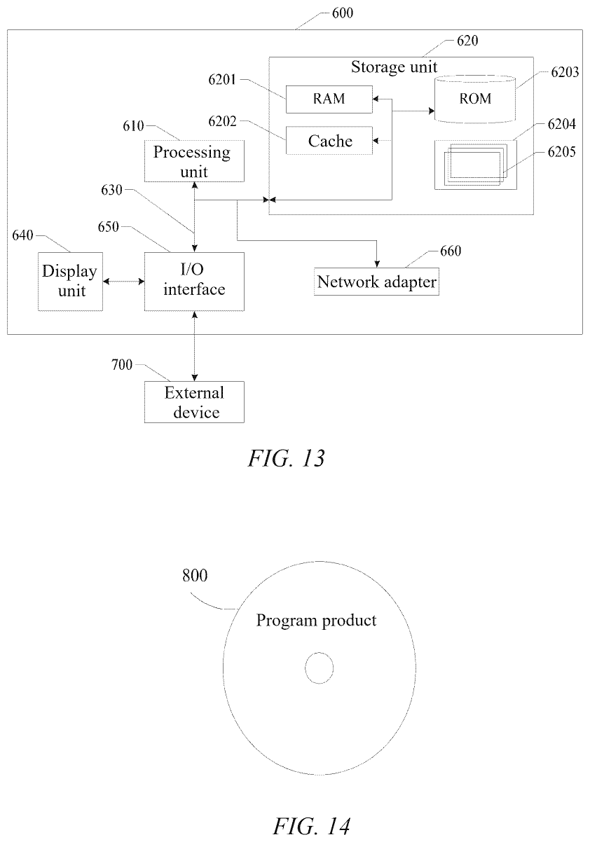

An electronic device 600 according to such an implementation of the present disclosure is described below with reference to FIG. 13. The electronic device 600 shown in FIG. 13 is merely an example, and should not impose any limitation on the function and usage range of the embodiments of the present disclosure.

As shown in FIG. 13, the electronic device 600 is embodied in the form of a general-purpose computing device. Components of the electronic device 600 may include, but are not limited to: at least one processing unit 610, at least one storage unit 620, a bus 630 for connecting different system components (including the storage unit 620 and the processing unit 610), and a display unit 640.

The storage unit stores program code, which can be executed by the processing unit 610, such that the processing unit 610 performs the steps according to various exemplary implementations of the present disclosure described in the above “Vehicle Interior System” section of the description. For example, the processing unit 610 may perform the steps as shown in FIG. 5.

The storage unit 620 may include a readable medium in the form of a volatile memory unit, such as a random access memory (RAM) 6201 and/or a cache 6202, and may further include a read-only memory (ROM) 6203.

The storage unit 620 may further include a program/utility tool 6204 having a set of (at least one) program modules 6205, such program modules 6205 including but not limited to: an operating system, one or more application programs, and other program modules and program data, where each of or a certain combination of these examples may include the implementation of a network environment.

The bus 630 may represent one or more of several types of bus structures, including a storage unit bus or storage unit controller, a peripheral bus, a graphics acceleration port, a processing unit, or a local area bus using any of a variety of bus structures.

Alternatively, the electronic device 600 may communicate with one or more external devices 700 (e.g., a keyboard, a pointing device, a Bluetooth device, etc.), or may communicate with one or more devices that enable a user to interact with the electronic device 600, and/or communicate with any device (e.g., a router, a modem, etc.) that enables the electronic device 600 to communicate with one or more other computing devices. The communication may be performed via an input/output (I/O) interface 650. In addition, the electronic device 600 may also communicate with one or more networks (e.g., a local area network (LAN), a wide area network (WAN), and/or a public network, such as the Internet) via a network adapter 660. The network adapter 660 may communicate with other modules of the electronic device 600 through the bus 630. It should be understood that, although not shown in the figure, other hardware and/or software modules may be utilized in conjunction with the electronic device 600, including but not limited to: microcode, a device driver, a redundant processing unit, an external disk drive array, a RAID system, a tape drive, a data backup storage system, etc.

In the vehicle interior component adjustment device, when the program in the memory is executed by a processor, the steps of the vehicle interior system are implemented. Therefore, the device can also achieve the technical effect of the above vehicle interior system.

An embodiment of the present disclosure further provides a computer-readable storage medium for storing a program, where when the program is executed by a processor, the steps of the described vehicle interior system are implemented. In some possible implementations, various aspects of the present disclosure may also be implemented as a program product including program code, where when the program product is executed on a terminal device, the program code is used to enable the terminal device to perform the steps according to various exemplary implementations of the present disclosure described in the above “Vehicle Interior System” section of the description.

Referring to FIG. 14, a program product 800 according to an implementation of the present disclosure for implementing the above method is described. The program product may be a portable compact disk read-only memory (CD-ROM), and includes program code, and may be executed on a terminal device, for example, a personal computer. However, the program product of the present disclosure is not limited thereto. In this document, the readable storage medium may be any tangible medium containing or storing a program which may be used by or in combination with an instruction execution system, apparatus or device.

The program product may employ any combination of one or more readable media. The readable medium may be a readable signal medium or a readable storage medium. The readable storage medium may be, for example, but is not limited to, electric, magnetic, optical, electromagnetic, infrared, or semiconductor systems, apparatuses, or devices, or any combination thereof. More specific examples of the readable storage media (a non-exhaustive list) include: an electrical connection having one or more wires, a portable disk, a hard disk, a random access memory (RAM), a read only memory (ROM), an erasable programmable read only memory (EPROM or flash), fiber optics, a portable compact disk read only memory (CD-ROM), an optical storage device, a magnetic storage device, or any suitable combination thereof.

The computer-readable storage medium may include data signals in a baseband or propagated as parts of carriers, in which readable program code is carried. The propagated data signal may be in various forms, including but not limited to an electromagnetic signal, an optical signal, or any suitable combination thereof. The readable storage medium may also be any readable medium beyond the readable storage media. The readable medium is capable of sending, propagating or transmitting a program used by or in combination with an instruction execution system, apparatus or device or a combination. The program code contained in the readable medium may be transmitted by any appropriate medium, including but not limited to wireless, wired, optical cable, RF, etc., or any appropriate combination of the above.

The program code for executing operations of the present disclosure may be compiled using one or more programming languages. The programming languages include object-oriented programming languages, such as Java and C++, and also include conventional procedural programming languages, such as “C” language or similar programming languages. The program code may be completely executed on a computing device of a user, partially executed on a user device, executed as a separate software package, partially executed on a computing device of a user and partially executed on a remote computing device, or completely executed on a remote computing device or server. In the case of a remote computing device, the remote computing device can be connected to a user computing device via any kind of network, including a local area network (LAN) or a wide area network (WAN), or can be connected to an external computing device (for example, connected via the Internet with the aid of an Internet service provider).

When the program in the computer storage medium is executed by a processor, the steps of the described vehicle interior system are implemented. Therefore, the computer storage medium can also achieve the technical effect of the above vehicle interior system.

The above is a further detailed description of the present disclosure with reference to the specific preferred implementations, and it cannot be considered that the specific implementation of the present disclosure is limited to these descriptions. For those of ordinary skill in the art of the present disclosure, several simple deductions or substitutions can be further made without departing from the concept of the present disclosure, and should be regarded as falling within the scope of protection of the present disclosure.

1. A vehicle interior system, comprising:
an interior component provided in a cockpit of a vehicle, the interior component comprising an infrared reflective material;
at least one TOF camera provided in the cockpit of the vehicle; and
an adjustment controller, comprising:
a data acquisition module configured to acquire detection data from the TOF camera;
a pose determination module configured to determine a pose of at least one occupant based on the detection data from the TOF camera; and
an interior adjustment module configured to determine an adjustment strategy for the interior component based on a pose of at least one interior component and the pose of the occupant, to provide a best match between the pose of the interior component and the pose of the at least one occupant.

2. The vehicle interior system according to claim 1, wherein the data acquisition module is configured to acquire the detection data from the TOF camera upon acquisition of a start signal of the TOF camera.

3. The vehicle interior system according to claim 1, wherein the pose comprises position information and posture information, wherein the pose information of the interior component and the pose information of the occupant are both determined based on the same reference coordinate system.

4. The vehicle interior system according to claim 1, wherein the interior adjustment module comprises:
a target acquisition module configured to acquire a target pose of each of one or more interior components corresponding to the at least one occupant;
a path planning module configured to determine an adjustment path for the interior component based on a current pose of the at least one interior component, the target pose thereof, and the pose of the at least one occupant, such that the adjustment path does not interfere with the pose of the occupant; and
an instruction sending module configured to generate an adjustment instruction based on the adjustment path, and send the adjustment instruction to the interior component.

5. The vehicle interior system according to claim 4, wherein the path planning module is configured to determine the adjustment path for the interior component based on the pose of the at least one interior component and poses of a plurality of occupants, such that the adjustment path does not interfere with the plurality of occupants.

6. The vehicle interior system according to claim 4, wherein the pose determination module is further configured to query a pre-stored current pose of the at least one interior component, or to determine the current pose of the at least one interior component based on the detection data from the TOF camera.

7. The vehicle interior system according to claim 4, wherein the target acquisition module is configured to acquire a body parameter of the occupant, and determine the target pose based on the body parameter of the occupant by using a preset target pose calculation algorithm.

8. The vehicle interior system according to claim 7, wherein the determining, by the target acquisition module, the target pose based on the body parameter of the occupant by using a preset target pose calculation algorithm comprises: querying a mapping table between preset target poses and body parameters, to acquire the target pose corresponding to the body parameter of the occupant.

9. The vehicle interior system according to claim 4, wherein the interior adjustment module further comprises:
a motion simulation module configured to acquire poses of the occupant at different moments from the pose determination module, and predict a motion trajectory of the occupant based on the poses of the occupant at the different moments by using a preset motion trajectory prediction algorithm, to determine poses of the occupant at individual predetermined moments; and
an interference ascertainment module configured to ascertain whether the adjustment path planned by the path planning module may interfere with the motion trajectory of the occupant at the individual predetermined moments.

10. The vehicle interior system according to claim 1, wherein the determining, by the pose determination module, the pose of each of the at least one occupant based on the detection data from the TOF camera comprises:
determining a relative position of each of at least one feature point of the occupant and a reference point based on the detection data from the TOF camera; and
determining the pose of the at least one occupant based on the at least one feature point.

11. The vehicle interior system according to claim 10, wherein the pose determination module is further configured to perform the following steps:
acquiring the detection data from the TOF camera;
determining a position of a fixed point in the vehicle based on the detection data; and
establishing an in-vehicle spatial coordinate system with the fixed point as the reference point.

12. The vehicle interior system according to claim 1, wherein the system further comprises:
a pose ascertainment module configured to ascertain whether a current pose of the interior component meets a preset condition for correct pose; and/or
a relative position ascertainment module configured to ascertain whether a relative position of the interior component and the occupant meets a preset condition for correct relative position.

13. The vehicle interior system according to claim 1, wherein the interior component comprises a vehicle seat assembly and/or a steering wheel assembly.

14. The vehicle interior system according to claim 13, wherein the interior component further comprises a seat belt assembly, wherein the seat belt assembly comprises a fixed portion and a webbing portion, and the pose information of the interior component comprises at least position information of the webbing portion and a degree of twist of the webbing portion.

15. The vehicle interior system according to claim 1, wherein the infrared reflective material is provided for the interior component in at least one of the following ways:
a surface of the interior component being coated with the infrared reflective material as a film;
a surface of the interior component being applied with the infrared reflective material as a coating; and
the infrared reflective material being mixed with a raw material of the interior component.

16. A method for adjusting an interior component of a vehicle, wherein the interior component has a layer of infrared reflective material provided on a surface thereof, and the vehicle has at least one TOF camera provided therein,
the method comprising the following steps:
acquiring detection data from the TOF camera;
determining a pose of each of at least one occupant based on the detection data from the TOF camera; and
determining an adjustment strategy for the interior component based on a pose of at least one interior component and the pose of the at least one occupant, to provide a best match between the pose of the interior component and the pose of the occupant.

17. The method for adjusting an interior component of a vehicle according to claim 16, wherein the determining an adjustment strategy for the interior component based on a pose of at least one interior component and the pose of the at least one occupant comprises the following steps:
acquiring a current pose of the at least one interior component;
acquiring a target pose of each of one or more interior components corresponding to the at least one occupant; and
determining an adjustment path for the interior component based on the current pose of the at least one interior component, the target pose thereof, and the pose of the at least one occupant, such that the adjustment path does not interfere with the pose of the occupant.

18. The method for adjusting an interior component of a vehicle according to claim 17, wherein the determining an adjustment strategy for the interior component based on a pose of at least one interior component and the pose of the at least one occupant comprises the following step:
determining the adjustment strategy for the interior component based on the pose of the at least one interior component and poses of a plurality of occupants, such that the adjustment path for the interior component does not interfere with the plurality of occupants.

19. The method for adjusting an interior component of a vehicle according to claim 17, wherein the acquiring a current pose of the at least one interior component comprises:
querying a pre-stored current pose of the at least one interior component, or determining the current pose of the at least one interior component based on the detection data from the TOF camera.

20. The method for adjusting an interior component of a vehicle according to claim 17, wherein the acquiring a target pose of each of one or more interior components corresponding to the at least one occupant comprises the following steps:
acquiring a body parameter of the occupant; and
determining the target pose based on the body parameter of the occupant by using a preset target pose calculation algorithm.

21. The method for adjusting an interior component of a vehicle according to claim 20, wherein the determining the target pose based on the body parameter of the occupant by using a preset target pose calculation algorithm comprises the following step:
querying a mapping table between preset target poses and body parameters, to determine the target pose corresponding to the body parameter of the occupant.

22. The method for adjusting an interior component of a vehicle according to claim 17, wherein after the determining an adjustment path for the interior component based on the current pose of the at least one interior component, the target pose thereof, and the pose of the at least one occupant, the method further comprises the following steps:
predicting a motion trajectory of the occupant based on poses of the occupant at different moments by using a preset motion trajectory prediction algorithm, to determine poses of the occupant at individual predetermined moments;
ascertaining whether the adjustment path may interfere with the motion trajectory of the occupant at the individual predetermined moments; and
if yes, issuing an alarm notification; or
if no, generating an adjustment instruction based on the adjustment path, and sending the adjustment instruction to the interior component.

23. The method for adjusting an interior component of a vehicle according to claim 16, wherein the determining a pose of each of at least one occupant based on the detection data from the TOF camera comprises the following steps:
determining a relative position of each of at least one feature point of the occupant and a reference point based on the detection data from the TOF camera; and
determining the pose of the occupant based on the at least one feature point.

24. The method for adjusting an interior component of a vehicle according to claim 23, wherein the method further comprises the following steps:
acquiring the detection data from the TOF camera;
determining a position of a fixed point in the vehicle based on the detection data; and
establishing an in-vehicle spatial coordinate system with the fixed point as the reference point.

25. The method for adjusting an interior component of a vehicle according to claim 17, wherein after separately determining the current pose of the interior component and the pose of the occupant based on the detection data from the TOF camera, the method further comprises the following steps:
ascertaining whether the current pose of the interior component meets a preset condition for correct pose, and/or ascertaining whether a relative position of the interior component and the occupant meets a preset condition for correct relative position; and
if the current pose of the interior component does not meet the preset condition for correct pose, and/or the relative position does not meet the preset condition for correct relative position, issuing an alarm notification.

26. The method for adjusting an interior component of a vehicle according to claim 17, wherein the interior component comprises a vehicle seat assembly and/or a steering wheel assembly.

27. The method for adjusting an interior component of a vehicle according to claim 26, wherein the interior component further comprises a seat belt assembly, wherein the seat belt assembly comprises a fixed portion and a webbing portion, and pose information of the interior component comprises at least position information of the webbing portion and a degree of twist of the webbing portion.

28. A vehicle interior component adjustment device, comprising:
a processor; and
a memory storing instructions executable by the processor,
wherein the processor is configured to execute, by executing the executable instructions, the steps of the method for adjusting an interior component of a vehicle according to claim 17.

29. A computer-readable storage medium for storing a program, wherein when the program is executed by a processor, the steps of the method for adjusting an interior component of a vehicle according to claim 17 is implemented.
